(19) United States
(12) Patent Application Publication
(10) Pub. No.: US 2021/0227808 A1
(43) Pub. Date: Jul. 29, 2021

(54) DEVICE AND METHOD FOR FISH REPRODUCTION, HATCHING AND LARVAL CULTURE

(71) Applicant: Suzhou Fishseeds Bio-Technology Co., Ltd., Suzhou (CN)

(72) Inventors: Qinghua LIU, Suzhou (CN); Naomi SUDO, Suzhou (CN); Han MENG, Suzhou (CN)

(21) Appl. No.: 17/227,424

(22) Filed: Apr. 12, 2021

Related U.S. Application Data
(63) Continuation-in-part of application No. PCT/CN2018/109840, filed on Oct. 11, 2018.

(30) Foreign Application Priority Data
Oct. 10, 2018 (CN) 201811175463.6

(51) Int. Cl. A01K 63/04; A01K 63/00; A01K 61/17

(52) U.S. Cl. CPC A01K 63/047; A01K 61/17; A01K 63/003

(57) ABSTRACT

A device for fish reproduction, hatching and larval culture including an aeration device, a first netted division plate, a second netted division plate, a first water pump, a first net cage, a second water pump, and a second net cage. When in use, the device is disposed in a pond. The pond includes a breeding area, a hatching area, and a nursery area, and each of the breeding area, the hatching area, and the nursery area communicates with the other two. The first netted division plate is disposed between the breeding area and the hatching area, and a first water recirculating loop is formed between the breeding area and the hatching area to drive water to flow from the breeding area to the hatching area, and back to the breeding area. The second netted division plate is disposed between the hatching area and the nursery area.

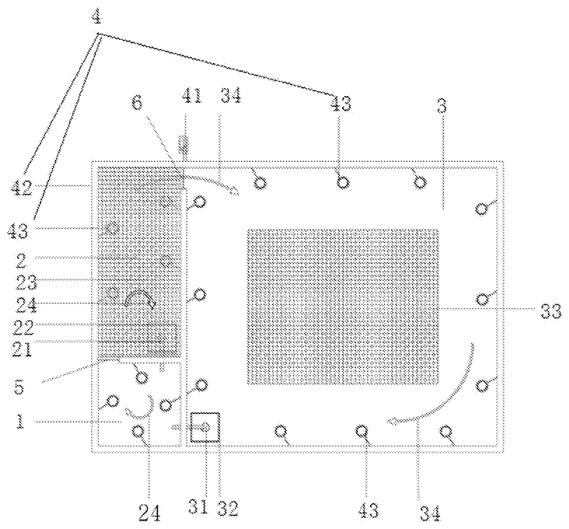

### CROSS-REFERENCE TO RELATED APPLICATIONS

This application is a continuation-in-part of International Patent Application No. PCT/CN2018/109840 with an international filing date of Oct. 11, 2018, designating the United States, now pending, and further claims foreign priority benefits to Chinese Patent Application No. 201811175463.6 filed Oct. 10, 2018. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of aquaculture technology, and more particularly, to a device and method for fish reproduction, hatching, and larval culture.

Artificially hormone-induced spawning is the main technology for artificial reproduction of fish. Specifically, the broodfish with mature gonads are injected with hormone to induce spawning or ripening, the fertilized eggs obtained by artificial insemination are hatched in incubation equipment, and then the larvae are moved to a nursery pond. However, the gonadal maturity of the broodfish is difficult to judge, so that many broodfish are needed to be prepared, and the operations of spawning induction are repeated for many times, which is harmful to the broodfish. Once spawning induction is conducted, if no eggs are laid, the broodfish will die due to gonadal expansion.

Artificial induction of natural spawning of fish is more advantageous. That is, in the breeding season, the broodfish with mature gonads are put into a spawning pond with appropriate nutrition, temperature, light, water flow and so on, to induce their natural spawning. However, the gonadal development of the broodfish is not synchronous and the environment that the broodfish live in is unstable, the spawning period often lasts more than two months, so that the laid eggs cannot be collected in a centralized way. Therefore, the fry hatched in different time grow to different sizes, which leads to killing each other, resulting in low survival rates.

### SUMMARY

The disclosure provides a device for fish natural reproduction, hatching and larval culture. The device comprises an aeration device, a first netted division plate, a second netted division plate, a first water pump, a first net cage, a second water pump, and a second net cage. When in use, the device for fish reproduction, hatching and larval culture is disposed in a pond. The pond comprises three parts: a breeding area, a hatching area, and a nursery area, which are connected in order. The first netted division plate is disposed between the breeding area and the hatching area, and the second netted division plate is disposed between the hatching area and the nursery area. The aeration device comprises a plurality of air outlets disposed in the breeding area, the hatching area, and the nursery area. The first net cage is disposed in the hatching area and the first water pump is disposed in the first net cage. The first water pump is configured to pump the water from the hatching area to the breeding area to form a first water recirculating loop. The second net cage is disposed in the nursery area and the second water pump is disposed in the second net cage. The second water pump is configured to pump the water from the nursery area to the breeding area to form a second water recirculating loop.

In a class of this embodiment, the device for fish reproduction and hatching further comprises a first sunshade disposed over the hatching area.

In a class of this embodiment, the device for fish reproduction and hatching further comprises a second sunshade disposed over the nursery area.

In a class of this embodiment, the aeration device comprises an air blower, a vent pipe, and a plurality of air stones or aero-tubing. The plurality of air stones or aero-tubing is disposed in the breeding area, the hatching area, and the nursery area; and the air blower is a turbo air blower.

In a class of this embodiment, the first netted division plate and the second netted division plate are 5-40 mesh net.

The disclosure further provides a method for fish reproduction, hatching and larval culture using the device, the method is implemented as follows:

1. Aeration: aerating, by the aeration device, to provide the breeding area, the hatching area, and the nursery area with sufficient dissolved oxygen.

2. Breeding: putting broodfish with developed gonads in the breeding area; pumping, by the first water pump, water from the hatching area to the breeding area, which makes the water in the breeding area to flow through the first netted division plate into the hatching area, thus forming a first water recirculation loop between the hatching area and the breeding area. The water flow of the first water recirculating loop stimulates the development of the gonads of the broodfish and induces the broodfish naturally spawn eggs, and moves the eggs or fry into the hatching area. The eggs may be sticky eggs, floating eggs, and semi-buoyant eggs, respectively; placing a fish nest in the breeding area to collect the sticky eggs; aerating the breeding area to evenly distribute the floating eggs and the semi-buoyant eggs in the water, when the water flows from the breeding area to the hatching area via the first netted division plate, the floating eggs and the semi-buoyant eggs enter the hatching area along with the water flow of the first water recirculating loop; and removing the broodfish out of the breeding area after broodfish spawn.

3. Hatching: culturing zooplankton in the nursery area 10-20 days before hatching; hatching the eggs into fish larvae in the hatching area; when the larvae start to swim, switching on the second water pump, and the water is pumped from the nursery area to the breeding area, the water in the breeding area flows through the first netted division plate into the hatching area, and flows from the hatching area through the second netted division plate into the nursery area, thus forming the second water recirculating loop among the breeding area, the hatching area, and the nursery area, and the larvae swim through the second netted division plate into the nursery area along with the water flow of the second water recirculating loop.

4. Rearing: rearing the larvae in the nursery area.

According to the different physiological characteristics and ecological requirements of breeding and rearing of fish, the method of the disclosure divides the pond into the breeding area, the hatching area, and the nursery area. The design allows the broodfish to adapt to the spawning environment as soon as possible, and provides the simulated ecological conditions for the natural development and maturity of the gonads, natural spawning, hatching and rearing of fish, respectively. In addition to the same requirements for water quality, the three areas have completely independent and different ecological requirements and production functions.

In the breeding area, the water current circulates unidirectionally, sunlight exposure is enough, and the water ecological environment is stable and with excellent water quality (NH₃<0.1, NO₂<0.05), meeting the special needs of broodfish gonad development for water flow stimulation, natural daily temperature fluctuation, daily photoperiod and with good water quality. The broodfish, which are placed in such a breeding area, can adapt to the spawning environment as soon as possible, promote the natural development and maturation of the gonads, and spawn naturally. The produced fertilized eggs or larvae enter the hatching area along with the water flow of the first water recirculating loop and hatch naturally.

In the hatching area, the environment is kept in sunshade and the aeration is evenly distributed to satisfy the fondness of fertilized eggs and newly hatched larvae and to avoid the harm of solar radiation. Before hatching, the green water is cultured in the nursery area in advance so that the water is suitable for growth of zooplankton which will provide enough food for the newly hatched larvae.

In the nursery area, the green water, enough phytoplankton, nutrition, dissolved oxygen, aeration, mild sunlight are required. Fertilizer and green water with algae are required to meet the growth needs of zooplankton. After hatching, the newly hatched larvae enter the nursery area along with the continuous water flow of the second water recirculating loop, eat the zooplankton and grow up under gentle sunlight of sunshade in the green water.

After a batch of eggs is spawned, most of the eggs or the newly hatched larvae enter the hatching area along with the water flow of recirculation I. The broodfish are removed from the breeding area, to prevent the broodfish from eating the eggs or fry. Larger fry are separated from smaller fry to keep some from killing each other. The broodfish that have not spawned are relocated into a new spawning pond to spawn.

As the fry grow up, the fry are evenly distributed throughout the three areas, thus forming a fish breeding system, and the water recirculation larval culture system enhances the bio-treatment to improve the water quality.

The disclosure integrates the natural breeding method and recirculating larval culture system to form an easy-to-operate and stable nursery system that can be mass-produced, which saves labor costs and improves breeding efficiency.

The following advantages are associated with the device and method of the disclosure:

1. The method optimizes the breeding strategy for the broodfish before spawning and achieves higher spawn rate of fish over the prior art. On one hand, the breeding area provides a simulated ecological environment for the spawning population, which can promote development of the gonads, induce the synchronous development of the gonads, and increase the spawning rate of the broodfish. On the other hand, there is no need to use hormone injection to induce spawning, which avoids the stress response caused by traditional methods of induced spawning for fish. The device is especially effective for the breeds that have a strong response to stress, irregular gonadal development, or cannot be induced by artificially-induced spawning.

2. The method has little damage to the broodfish and the broodfish can be reused, achieving a multi-batch production. Larger fry are separated from smaller fry to keep some from killing each other. The fertilized eggs and the newly hatched larvae are introduced into the hatching area along with the water flow of the first water recirculating loop, so that the fishing net cannot cause damage to the fry when removing the broodfish out of spawning area.

3. The method has higher efficiency of reproduction, hatching and larval culture over the prior art. The first recirculating water loop integrates the spawning area and the hatching area and automatically hatches fish eggs, which overcome the problems of artificially hormone-induced spawning, for example, the operations of the later are complicated, time-consuming, and labor-intensive. The second recirculating water loop allows the newly hatched larvae to safely enter the nursery area comprising enough food, expanding the nursery area. The recirculating water improves the self-purification ability of the water in the device and is conducive to the growth of the zooplankton and fry.

4. The method integrates the spawning, hatching, and rearing processes, reduces the damage to the fertilized eggs and fry compared with the artificially hormone-induced spawning, increases the productivity of fish breeding and larval rearing.

5. The method is easy to operate, at lower cost, with strong controllability, without special equipment, which is suitable for the breeding and larval rearing of the valuable fish species that have stringent requirements for the culture environment.

### BRIEF DESCRIPTION OF THE DRAWINGS

The invention is described here in below with reference to accompanying drawings, in which the sole FIGURE is a schematic diagram of a device for fish reproduction, hatching and larval culture accordance to one embodiment of the disclosure.

### DETAILED DESCRIPTION

To further illustrate the disclosure, embodiments detailing a device for fish reproduction, hatching and larval culture of the disclosure are described below. It should be noted that the following embodiments are intended to describe and not to limit the disclosure.

### Example 1

Referring to the sole FIGURE, a device for fish reproduction, hatching and larval culture comprises a pond. The pond is divided into three parts: a breeding area 1, a hatching area 2, and a nursery area 3, which are connected to each other. The pond further comprises an aeration device 4. A first netted division plate 5 is disposed between the breeding area 1 and the hatching area 2, and a second netted division plate 6 is fastened between the hatching area 2 and the nursery area 3. The first netted division plate 5 and the second netted division plate 6 are 5-40 mesh nettings.

The aeration device 4 comprises an air blower 41, a vent pipe 42, and a plurality of air stones or aero-tubing 43. The plurality of air stones or aero-tubing 43 is disposed in the breeding area 1, the hatching area 2, and the nursery area 3.

The air blower 41 is a turbo air blower.

The device for fish reproduction, hatching and larval culture further comprises a first water pump 21, a first net cage 22, and a first sunshade 23. The first net cage 22 is disposed in the hatching area 2 and the first water pump 21 is disposed in the first net cage 22. The first water pump 21 is configured to pump the water from the hatching area 2 to the breeding area 1. The first sunshade 23 is disposed over the hatching area 2.

The device further comprises a second water pump 31, a second net cage 32, and a second sunshade 33. The second net cage 32 is disposed in the nursery area 3 and the second water pump 31 is disposed in the second net cage 32. The second water pump 31 is configured to pump the water from the nursery area 3 to the breeding area 1. The second sunshade 33 is disposed over the nursery area 3.

A method for fish reproduction, hatching and larval culture using the device is described as follows:

1. Aeration:

A pond is built from earth or cement, and divided into the breeding area 1, the hatching area 2, and the nursery area 3. Since spring weather is unpredictable, a greenhouse pond can be used to provide a suitable and stable environment for the breeding, hatching, and rearing and to minimize the weather and climate impacts.

Prior to using the pond, the aeration device 4 is used to aerate the breeding area 1, the hatching area 2, and the nursery area 3, thus evenly distributing air to the three areas and providing sufficient dissolved oxygen. That is, the aeration device 4 uses the turbo air blower to pump the air through the vent pipe to the three areas. The plurality of air stones or aero-tubing 43 is distributed evenly in the three areas, supplying evenly distributed oxygen in the three areas.

2. Breeding: Broodfish are used in the breeding area for breeding purpose.

The broodfish with well-developed gonads are put in the breeding area 1. The first net cage 22 is disposed in the corner of the hatching area 2 that is adjacent to the breeding area 1. The first net cage 22 has a 60-100 mesh and the first water pump 21 is disposed in the first net cage 22. The first net cage 22 is configured to prevent fish eggs and larvae from entering the first net cage 22, thus avoiding suctioning the fish into the first water pump 21. The breeding area 1 and the hatching area 2 are separated by the first netted division plate 5 having a 5-40 mesh, thus preventing the broodfish from entering the hatching area 2 from the breeding area 1.

The first water pump 21 is configured to pump the water from the hatching area 2 to the breeding area 1, and the water in the breeding area 1 flows through the first netted division plate 5 into the hatching area 2, thus circulating the water between the breeding area 1 and the hatching area 2. Water flow stimulates the development of gonad of the broodfish and thus the broodfish lay eggs. Since the laid eggs comprises sticky eggs, floating eggs, and semi-buoyant eggs. A fish nest is disposed in the breeding area 1 and used for collection of sticky eggs. The aeration device 4 is configured to evenly distribute air to the breeding area 1, so that the floating eggs and semi-buoyant eggs are evenly distributed in the water. The floating eggs, semi-buoyant eggs, and newly hatched larvae swim into the hatching area 2 along with the water flows of the first water recirculating loop from the breeding area 1 through the first netted division plate 5 to the hatching area 2.

After a batch of eggs is spawned, the broodfish are caught and removed out of the breeding area 1, thus preventing the broodfish from eating the eggs or fry, and separating larger fry from smaller fry to keep some from killing each other. The broodfish that have not spawned are put into a new spawning pond and allowed to spawn.

3. Hatching: the eggs are hatched in the hatching area 2.

The hatching area 2 is completely covered by the first sunshade 23, to avoid damage to the fertilized eggs caused by solar radiation.

10-20 days prior to hatching, green water is prepared in the nursery area 3 so that the water is suitable for growth of rotifers, cladocerans and other zooplankton. The second net cage 32 is disposed at the junction of the breeding area 1 and the nursery area 3. The second water pump 31 is disposed in the second net cage 32. When the eggs are hatched out and the newly hatched larvae start to swim, the second water pump 31 is switched on, thus pumping the water from the nursery area 3 to the breeding area 1. The water in the breeding area 1 flows through the first netted division plate 5 into the hatching area 2, and flows from the hatching area 2 through second netted division plate 6 into the nursery area 3, thus forming a second water recirculating loop 34 among the breeding area 1, the hatching area 2, and the nursery area 3. The newly hatched larvae swim into the nursery area 3 along with the water flow of the second water recirculating loop through the second netted division plate 6 to the nursery area 3.

4. Larval rearing: the newly hatched larvae are reared in the nursery area 3.

The second sunshade 33 is disposed over the center of the nursery area 3, to shade part of the nursery area 3. Sunlight has an important role in promoting the breeding of the plankton, but has high levels of radiation which can kill the fry, especially the new hatched larvae. Partially-covered structure provides protection for the larvae and allows sunlight to plankton. When the sunlight is strong, the larvae hide under the second sunshade 33, to protect themselves from solar radiation.

As the fry grow up, the fry can enter and leave the breeding area 1 and the hatching area 2, and are evenly distributed throughout the three areas, thus forming a recirculating larval culture system.

### Example 2

Natural breeding and nursery of black crappie in the device of the disclosure.

Black crappie (Pomoxis nigromaculatus) is an important freshwater fish for sport-fishing in America. The black crappie was introduced to China in the late 20st century. Its meat is tender and delicious, without intermuscular bones, and thus the fish is favored in the market.

The female black crappie lay eggs in the nests and the male black crappie guard the nest. Traditional methods of hormone-induced spawning for the black crappie have problems with success, which leads to severe fingerling shortage and limits its culture business.

The main reason for the low reproductive efficiency of the black crappie is its special biological characteristics. The black crappie is a carnivorous fish and spawn multiple times in one season. The number of eggs spawn at one time is limited due to its small gonads. Also, the black crappie has a strong stress response and thus is easily damaged by the artificially hormone-induced spawning, resulting low efficiency of spawning. Therefore, natural spawning is the method suitable for reproduction in the black crappie. However, after spawning, the broodfish has to be remove from the pond, otherwise, the broodfish will eat the eggs or fry, and because crappie is multiple spawners, separating larger fry from smaller fry to keep some from killing each other. However, the fishing net may cause damage to the fry when catching the broodfish.

A pond is divided into three parts: a breeding area 1, a hatching area 2, and a nursery area 3. The pond further comprises an aeration device 4. The aeration device 4 comprises an air blower 41, a vent pipe 42, and a plurality of air stones or air aero-tubing 43. The aeration device 4 uses the air blower to supply the air through the vent pipe 42 to the three areas. The plurality of air stones or air aero-tubing 43 is distributed evenly in the three areas, supplying evenly distributed oxygen in the three areas.

The black crappie is sensitive to environmental conditions, and thus has a stronger stress response. In early spring, when the water temperature is higher than 15° C., the broodfish with well-developed gonads are put in the breeding area 1 for breeding before spawning. The breeding area 1 and the hatching area 2 are separated by the first netted division plate 5 (having a 5-40 mesh), thus preventing the broodfish from entering the hatching area 2 from the breeding area 1. The first net cage 22 is disposed in the corner of the hatching area 2 that is adjacent to the breeding area 1. The first net cage 22 has a 60-100 mesh and the first water pump 21 is disposed in the first net cage 22. The first water pump 21 is configured to pump the water from the hatching area 2 to the breeding area 1, thus forming a first water recirculation loop 24 between the breeding area 1 and the hatching area 2. The water flow stimulates the development of gonad of the broodfish. When the gonads mature and the water temperature is higher than 18-22° C., male black crappies build nests at the bottom of the breeding area 1, thus attracting female black crappies to the nests for laying eggs. The male black crappie squeeze out the semen and the eggs are fertilized by the semen. The male black crappies chase the female black crappies away the nests and protect the eggs from being eaten by other fish.

After hatching of 2-3 days, the eggs are hatched out and the newly hatched larvae start to swim in the breeding area 1. The newly hatched larvae swim from the breeding area 1 into the hatching area 2 along with the water flow of the first water recirculating loop and gather in the hatching area 2. The first net cage 22 is configured to prevent fish eggs and larvae from entering the first net cage 22, thus avoiding the suction of the first water pump 21. The hatching area 2 is completely covered by the first sunshade 23, to avoid damage to the newly hatched larvae caused by solar radiation. After a batch of eggs is spawned, the broodfish are caught and removed from the breeding area 1, to prevent the broodfish from eating the eggs or fry, and separating larger fry from smaller fry to keep some from killing each other. The broodfish that have not spawned are transferred into a new spawning pond to spawn again. The most of newly hatched larvae get into the hatching area 2 along with the water flow of the first water recirculating loop before the relocation of broodfish, so that netting the broodfish causes little damage to the fry in breeding area.

The second net cage 32 is disposed at the junction of the breeding area 1 and the nursery area 3. The second water pump 31 is disposed in the second net cage 32. When the newly hatched larvae start to swim, the second water pump 31 is switched on, thus pumping the water from the nursery area 3 to the breeding area 1, thus forming a second water recirculating loop 34 among the three areas. The newly hatched larvae swim into the nursery area 3 along with the water flow of the second water recirculating loop through the second netted division plate 6 to the nursery area 3. The newly hatched larvae are fed with the zooplankton and grow in the nursery area 3. The second sunshade 33 is disposed over the center of the nursery area 3, to shade part of the nursery area 3. Sunlight has an important role in promoting the breeding of the plankton, but has high levels of radiation which can kill the fry, especially the newly hatched larvae. Partially-covered structure provides protection area for the larvae, allows sunlight to nurse the plankton, and increase the temperature of the water, thus promoting the rapid growth of the zooplankton. When the sunlight is strong, the larvae will hide under the second sunshade 33, to protect themselves from solar radiation. As the fry grow up, the fry can swim upstream and enter the breeding area 1 and the hatching area 2 freely, and are evenly distributed throughout the three areas, thus forming a recirculating larval culture system.

During the rearing period, the water should be kept recirculating in the three areas and the probiotics should be regularly used. For example, Bacillus, nitrifying bacterium and lactic acid bacteria should be sprayed in the pond 1-6 times a month, thus enhancing the capacity of probiotics to improve the water quality, and maintaining a healthy microbial flora for water bio-treatment.

The device of the disclosure improved the spawning efficiency and survival rate of breeding of the black crappie. In the device comprising a pond of 600 square meters, the black crappie achieves a spawning efficiency of 83%, without loss of a single broodfish, thereby obtaining 127,000 fingerlings with a body length of 3 cm.

### Example 3

Natural breeding and nursery of barramundi in the device of the disclosure.

Barramundi (Lates calcarifer) is a rare species of carnivorous fish, inhabiting South-East Asia, North Australia and Western Pacific coast. The barramundi is a large-scaled fish considered a delicacy, and thus is favored by European and American seafood markets. Because of its rapid growth and high productivity, the barramundi was introduced to China in the 1970s and favored by farmers in Hainan, Guangdong, Fujian and other places. The barramundi is euryhaline fish and suitable for aquaculture in seawater and freshwater, thus opening a bright prospect of barramundi aquaculture in inland and coastal areas. The barramundi has a low artificial reproduction rates (less than 30% reproductivity) and the fry depend heavily on imports, limiting the development of the barramundi aquaculture in China.

The major obstacles on the artificial reproduction of barramundi are hermaphrodite characteristics, high nutritional requirements, catadromous life cycle, long spawning season, and high demanding on environmental stability. Barramundi is a fast-growing species in freshwater under naturalistic conditions. 2-3-year-old barramundi weight 3-5 kg. 3-4-year-old barramundi migrates from inland waters to the coastal areas with a salinity of 30-32‰, and the gonads become mature and ready to spawn. Barramundi is a hermaphroditic fish that develop first as male by 3-4 years old and then switch to female by 5-6 years old. The female barramundi breed from April to August. Traditional methods of artificially hormone-induced spawning result in low spawning rate, low survival rate of larval culture, and significant cannibalism in fry. The supply of barramundi fingerlings depends on the import for a long period.

A device comprises a pond divided into a breeding area 1, a hatching area 2, and a nursery area 3. The pond further comprises an aeration device 4. The aeration device 4 comprises an air blower 41, a vent pipe 42, and a plurality of air stones or aero-tubing 43. The aeration device 4 uses the air blower to pump the air through the vent pipe 42 to the three areas. The plurality of air stones or aero-tubing 43 is distributed evenly in the three areas, supplying evenly distributed oxygen in the three areas.

The barramundi is sensitive to external environmental changes, and thus has a strong stress response to the human intervention, leading to asynchronous and poor gonad development of the broodfish. To break through the dilemma, a suitable and stable controlled culture environment, has to be established for the broodfish nutritional enrichment and reproduction of this species. In early spring, when the water temperature is higher than 15-18° C., the 3-year-old healthy broodfish are selected, with intact fish scales, no physical injury, and well-developed gonads. The selected broodfish are stocked in the breeding area 1 for adaptative nourishment before spawning, having a 1:1 to 1:1.5 sex ratio of females and males and a salinity range of 15-32‰. During the breeding period, the broodfish are fed with specially-made broodstock feed or chilled small fish, 2-3 times a day. The breeding area 1 and the hatching area 2 are separated by the first netted division plate 5 (having a 5-40 mesh), thus preventing the broodfish from entering the hatching area 2 from the breeding area 1. The first net cage 22 is disposed in the corner of the hatching area 2 that is adjacent to the breeding area 1 (the first net cage 22 has a 60-100 mesh). The first water pump 21 is disposed in the first net cage 22. The first water pump 21 is configured to pump the water from the hatching area 2 to the breeding area 1, thus forming a first water recirculating loop 24 between the breeding area 1 and the hatching area 2. Water flow stimulates the development of gonad of the broodfish. In the early stage of nursery, the salinity level in the pond is 15-25‰. When the gonads mature and the water temperature is higher than 25-30° C., the female barramundi are chased by the male barramundi and so it stimulates the female barramundi to lay her eggs. The fertilized eggs of the barramundi are floating eggs that float in the aerated breeding area. A part of the floating eggs get into the hatching area 2 along with the water flow of the first water recirculating loop. The eggs hatch out into larvae within 20 hours at 28° C., and then swim into the hatching area 2 from the breeding area 1 along with the water flow of the first water recirculating loop, and gather in the hatching area 2.

The first net cage 22 is configured to prevent the fertilized eggs and the newly hatched larvae from entering the first net cage 22, thus avoiding the suction of the first water pump 21. The hatching area 2 is completely covered by the first sunshade 23, to avoid damage to the fertilized eggs and the newly hatched larvae caused by solar radiation. After a batch of eggs is spawned, the broodfish are caught and removed out of the breeding area 1, thus preventing the broodfish from eating the eggs or fry, and separating larger fry from smaller fry to keep some from killing each other. The newly hatched larvae get into the hatching area 2 along with the water flow of the first water recirculating loop before the broodfish relocation, so that netting the broodfish causes little damage to the fry in breeding area.

The second net cage 32 is disposed at the junction of the breeding area 1 and the nursery area 3. The second water pump 31 is disposed in the second net cage 32. On the second day of hatching, the newly hatched larvae start to swim and the second water pump 31 is switched on, thus pumping the water from the nursery area 3 to the breeding area 1 and forming a second water recirculating loop 34 among the breeding area 1, the hatching area 2, and the nursery area 3. The newly hatched larvae swim into the nursery area 3 through the second netted division plate 6 along with the water flow of the second water recirculating loop, and then are fed with the zooplankton in the nursery area 3. 7-10 days before spawning of the barramundi, the fermented organic fertilizer (50-100 kg/mu) is applied in the nursery area 3, and green water is cultured and suitable for growth of zooplankton. The newly hatched larvae of the barramundi are small, 1.6 mm in length, and feed on the rotifers (60-100 um). During the first week of rearing, the number of the rotifers are determined per day to ensure there is no less than 4-6 rotifers/mL. During the rearing period, the stock solution of Chlorella and Isochrysis culture are added to the green water every 2-3 days, thus improving the nutrition in the zooplankton and increasing the survival rate of fry. On the 15-25th day of rearing, as the growth rate of the fry increases, the fry are fed with a mixture of surimi and fry capsule feed every day, and the amount of the mixture is gradually increased. The mixture feed is sprinkled to the water surface of the pond for 5-10 times throughout the day. The mixture feed is important for the supplement to shortage of natural food and gradually training on feed for the fry. When the fry reach a body length of 3-4 cm, the fry feed capsule is sprinkled on the surface of the water at a fixed time, quantity and location. When the fry reach a body length of 4-5 cm, the fry are caught, screened into different sizes of fingerlings, and reared in different ponds, thus separating larger fingerlings from smaller fingerlings to keep some from killing each other. When they reach a body length of 6-8 cm, the fingerlings are caught and screened again into different sizes. At this time, the barramundi fingerlings have been domesticated on feed, or no longer cannibalized each other, and can be sold or farmed.

The second sunshade 33 is disposed over the center of the nursery area 3, to shade part of the nursery area 3. Sunlight is important in promoting the growth of the algae and zooplankton, but its radiation is harmful to the fry, especially the larvae. Partially-covered sunshade structure provides protection for the larvae, allows some sunlight on plankton, and increase the temperature of the water, thus promoting the rapid growth of the zooplankton. When the sunlight is strong, the larvae hide under the second sunshade 33, to protect themselves from solar radiation. As the fry grow up, the fry may swim upstream and enter the breeding area 1 and the hatching area 2 freely, and are evenly distributed throughout the three areas, thus forming a recirculating larval culture system.

During the rearing period, the water should be kept recirculating in the three areas and the probiotics should be regularly used. For example, Bacillus, nitrifying bacterium and lactic acid bacteria should be sprayed in the pond 1-6 times a month, thus enhancing the capacity of probiotics to improve the water quality, and maintaining a healthy microbial flora for water bio-treatment.

The device of the disclosure improved the spawning efficiency and survival rate of larval culture for the barramundi, especially the efficiency of larval culture. The new-hatched fry of barramundi have a small size of about 1.62 mm. They grow slowly in the early stage and have a large yolk sac, at the same time, human disturbance may easily damage the fry, leading to a low survival rate. The method of the disclosure integrates the processes of cultivation and supplementation of zooplankton, providing sufficient live food for the fry for fast growth in the early stage, combining the newly hatched larvae and broodfish in a pond, and avoiding the muddy water from choking the fry when the fry are caught. In the device comprising a pond of 520 square meters, the barramundi achieves a spawning efficiency of 96% and obtains 73,000 juvenile fish having a body length of 6-8 cm. The individual size of the juvenile fish is uniform, which reduces the risk of juvenile fish killing each other.

It will be obvious to those skilled in the art that changes and modifications may be made, and therefore, the aim in the appended claims is to cover all such changes and modifications.

What is claimed is:

1. A device for fish reproduction, hatching and larval culture, the device comprising:
1) an aeration device;
2) a first netted division plate;
3) a second netted division plate;
4) a first water pump;
5) a first net cage;
6) a second water pump; and
7) a second net cage;
wherein:
when in use, the device for fish reproduction and hatching is disposed in a pond;
the pond comprises a breeding area, a hatching area, and a nursery area, and each of the breeding area, the hatching area, and the nursery area communicates with the other two;
the first netted division plate is disposed between the breeding area and the hatching area, and the second netted division plate is disposed between the hatching area and the nursery area;
the aeration device comprises a plurality of air outlets disposed in the breeding area, the hatching area, and the nursery area;
the first net cage is disposed in the hatching area and the first water pump is disposed in the first net cage; the first water pump is configured to pump the water from the hatching area to the breeding area, whereby a first water recirculating loop is formed between the breeding area and the hatching area to drive water to flow from the breeding area to the hatching area, and back to the breeding area;
the second net cage is disposed in the nursery area and the second water pump is disposed in the second net cage; and the second water pump is configured to pump the water from the nursery area to the breeding area, whereby a second water recirculating loop is formed among the breeding area, the hatching area, and the nursery area to drive water to flow from the hatching area to the nursery area, the breeding area, and back to the hatching area.

2. The device of claim 1, further comprising a first sunshade disposed over the hatching area.

3. The device of claim 1, further comprising a second sunshade disposed over the nursery area.

4. The device of claim 1, wherein the aeration device comprises an air blower, a vent pipe, and a plurality of air stones or aero-tubing; the plurality of air stones or aero-tubing is disposed in the breeding area, the hatching area, and the nursery area.

5. The device of claim 4, wherein the air blower is a turbo air blower.

6. The device of claim 1, wherein the first netted division plate and the second netted division plate are 5-40 mesh nettings.

7. A method for fish reproduction and hatching, the method being implemented using a device for fish reproduction and hatching, the device comprising an aeration device, a first netted division plate; a second netted division plate; a first water pump; a first net cage; a second water pump; and a second net cage;
the method comprising:
disposing the aeration device in a pond, the pond comprising a breeding area, a hatching area, and a nursery area; disposing the first netted division plate between the breeding area and the hatching area, and disposing the second netted division plate between the hatching area and the nursery area;
disposing the first net cage in the hatching area and disposing the first water pump in the first net cage; disposing the second net cage in the nursery area and disposing the second water pump in the second net cage;
aerating, by the aeration device, the pond to provide the breeding area, the hatching area, and the nursery area with dissolved oxygen;
putting broodfish with developed gonads in the breeding area; pumping, by the first water pump, water from the hatching area to the breeding area, and the water in the breeding area flowing through the first netted division plate into the hatching area, thus forming a first water recirculating loop between the breeding area and the hatching area, where the water flow of the first water recirculating loop stimulates the broodfish to lay eggs, and the eggs comprises sticky eggs, floating eggs, and semi-buoyant eggs; placing a fish nest in the breeding area to collect the sticky eggs; aerating the breeding area to evenly distribute the floating eggs and the semi-buoyant eggs in the water, when the water flows from the breeding area to the hatching area via the first netted division plate, the floating eggs, the semi-buoyant eggs, and the hatched fry enter the hatching area through the first netted division plate along with the water flow of the first water recirculating loop; and removing the broodfish out of the breeding area;
hatching the eggs in the hatching area to form larvae; culturing zooplankton in the nursery area 10-20 days before hatching; when the larvae start to swim, switching on the second water pump, and the water is pumped from the nursery area to the breeding area, the water in the breeding area flows through the first netted division plate into the hatching area, and flows from the hatching area through the second netted division plate into the nursery area, thus forming a second water recirculating loop among the breeding area, the hatching area, and the nursery area, and the larvae swim through the second netted division plate into the nursery area along with the water flow of the second water recirculating loop; and
rearing the larvae in the nursery area.
